(19) United States
(12) Patent Application Publication
(10) Pub. No.: US 2009/0102767 A1
(43) Pub. Date: Apr. 23, 2009

(54) Liquid Crystal Display Apparatus

(76) Inventor: Makoto Shiomi, Tenri-shi Nara (JP)

Correspondence Address: HARNESS, DICKEY & PIERCE, P.L.C., P.O. BOX 8910, RESTON, VA, 20195, US

(21) Appl. No.: 12/224,800

(22) PCT Filed: Dec. 12, 2006
(86) PCT No.: PCT/JP2006/324731

§ 371 Date: Sep. 5, 2008

(30) Foreign Application Priority Data
Mar. 27, 2006 (JP) 2006-086206

(51) Int. Cl. G09G 3/36

(52) U.S. Cl. 345/88

(57) ABSTRACT

In a liquid crystal display apparatus realizing a dual view display by bonding a liquid crystal panel and a parallax barrier, the parallax barrier separates display images by treating three pixels including R, G, and B pixels as one unit (one picture element). At this time, luminance variation due to crosstalk concentrates on a right-end pixel among the three pixels constituting the one picture element (in a case where each pixel receives data from a source line immediately on the left of the pixel). Accordingly, the right-end pixel is arranged to be a B pixel that has a low correlation with luminance information and in which influence of crosstalk is hard to be viewed.

### TECHNICAL FIELD

The present invention relates to a liquid crystal display apparatus that performs a dual view display, in particular, to a liquid crystal display apparatus that improves color reproducibility by reducing color crosstalk.

### BACKGROUND ART

A problem of crosstalk is pointed out as a specific problem in a TFT-LCD. The crosstalk occurs because adjacent pixels are connected via a parasitic capacitance. In other words, when an insulating film intervenes between a transparent electrode and a source line, a parasitic capacitance is produced between the transparent electrode and the source line. In the same manner, parasitic capacitances are produced between a gate line and the transparent electrode and between the source line and a common electrode, respectively. Due to influence of these parasitic capacitances and a capacitance of a liquid crystal itself, an electric potential of a display pixel becomes different from a desired voltage when a gate is turned OFF. Consequently, a display gradation becomes different from a desired gradation.

In other words, at the moment a gate is high, a desired voltage is applied to a display pixel that is connected to a TFT. However, when the gate is low, the pixel is connected to many peripheral electric circuits via parasitic capacitances. Because many of these peripheral electric circuits are related to panel design, a driving voltage can be set in advance in consideration of parasitic capacitances between the display pixel and the peripheral electric circuits. Therefore, the crosstalk caused by the parasitic capacitances that are formed between the display pixel and the peripheral electric circuits can be compensated in advance. However, an electric potential of a source line that drives other display pixel cannot be determined in advance. Therefore, it is difficult to compensate, in advance, crosstalk that is caused by other source line.

As illustrated in FIG. 7(a), in a liquid crystal display apparatus, source lines Si (“i” is an integer) and gate lines Gj (j is an integer) are provided to be orthogonal. At each intersection of source lines Si and gate lines Gj, a display pixel 100 and a switching element 200 are provided. Regarding a display pixel (A) among the display pixels 100, parasitic capacitances Csda, Csdb, Cgd, and Ccs are formed as follows. A display pixel (B) indicates a display pixel that is adjacent to the display pixel (A) in a direction along which a gate line is provided.

The details of the parasitic capacitances Csda, Csdb, Cgd, and Ccs are as follows:

the parasitic capacitance Csda: a parasitic capacitance that is formed between a source line S2 for driving display pixels (A) and the display pixel (A);

the parasitic capacitance Csdb: a parasitic capacitance that is formed between a source line S3 for driving display pixels (B) and the display pixel (A);

the parasitic capacitance Cgd: a parasitic capacitance that is formed between a gate line G2 for driving display pixels (A) and the display pixel (A); and

the parasitic capacitance Ccs: a parasitic capacitance that is formed between a common electrode line and the display pixel (A).

A capacitance of the display pixel (A) itself is Cp and a voltage which is applied to each gate line varies as shown in FIG. 7(b). Furthermore, while the display pixel (A) displays a G color, the display pixel (B) displays an R color or B color. In addition, in a case where a gradation of the display pixel (A) is LA and a gradation of the display pixel (B) is LB, LA≠LB.

In this case, at the time at which the gate is high, when a drain voltage +V(A) is applied to a liquid crystal part of the display pixel (A), a drain voltage −V (B) is applied to a liquid crystal part of the display pixel (B). Then, when a next gate line is turned ON, −V (A) is applied to the source line that drives the display pixel (A) and +V (B) is applied to a source line that drives the display pixel (B).

However, in the reality, the above-mentioned drain voltage is not applied directly to the display pixel (A). A drain voltage that is varied due to the influence of the parasitic capacitances is applied to the display pixel (A). Specifically, an effective value Va of a voltage that is applied to the display pixel (A) is represented by

Va=V(A)+(Csda*V(A)+Cgd*Vg+Csdb*V(B)+Ccs*Vc)/Cp,

where: Vg is a voltage that is applied to the gate line; and Vc is a voltage that is applied to an opposed electrode.

In this way, a voltage different from a desired drain voltage (A) is applied to the display pixel (A).

The parasitic capacitances Csda, Cgd, and Ccs that are formed between the display pixel (A) and the respective lines as mentioned above are predictable at a stage of designing. Therefore, a drain voltage can be set in consideration of values of the parasitic capacitances. Accordingly, these parasitic capacitances do not have much influence on a display gradation of the display pixel (A).

However, the calculation formula of the effective voltage Va above includes the parasitic capacitance Csdb and a drain voltage V(B). In other words, the voltage Va is influenced by the source line that is connected to the display pixel (B). This causes color crosstalk that changes the gradation of the display pixel (A) according to a display gradation of the display pixel (B). For example, Patent Document 1 discloses a method of solving the problem of the color crosstalk by correcting a display signal.

[Patent Document 1] Japanese Unexamined Patent Publication No. 202377/2005 (Tokukai 2005-202377 (published on Jun. 28, 2005))

### DISCLOSURE OF INVENTION

However, in a conventional arrangement, a circuit a process for correction become complicated.

Further, in a normal display mode in which the same image is displayed with respect to all display directions, color crosstalk mentioned above does not occur prominently for the following reason. That is, in a normal display state, image data of adjacent source lines are of the same image. In regard to luminances of the image data of the adjacent source lines, the image data that relate to R, G, and B colors are highly correlated to one another. Therefore, even if crosstalk occurs, influence of the crosstalk is hard to appear in a visible image.

On the other hand, recently, a display mode (hereinafter, referred to as a dual view display) in which different images can be displayed with respect to a plurality of display directions, respectively, is realized. In such a mode, a display panel is combined with a parallax barrier. In this dual view display, the problem of the crosstalk caused by other source line becomes particularly prominent.

That is, in the dual view display, as illustrated in FIG. 8, a specific viewing angle is given, by a parallax barrier 120 that is provided outside a display panel 110, to each of first and second images that are produced by the display panel 110. This allows, as illustrated in FIG. 9, displaying different images to a plurality of observers at different observation points, respectively.

In the dual view display, data of a different image is provided to each source line. The display is performed by separating, with the use of the parallax barrier, the different images into different directions, respectively. Accordingly, the image data of the adjacent source lines relate to different images, respectively. As a result, the influence of the crosstalk to a visible image becomes large.

The present invention is attained in view of the above problem. The object of the present invention is to reduce, by a simple method, color crosstalk in a liquid crystal display that performs a dual view display.

In order to achieve the object above, in a liquid crystal display of the present invention allowing a display mode (a dual view display) in which a different image can be displayed with respect to each of a plurality of display directions to be realized by bonding a liquid crystal panel and a parallax barrier, the liquid crystal panel being provided with a display pixel including a switching element and a pixel electrode which display pixel corresponds to each intersection of a plurality of gate lines and a plurality of source lines: the parallax barrier separates display images viewed in different directions, respectively, by treating, as one unit, three pixels including R, G, and B pixels provided in a direction in which a gate line is extended; and in a case where, among the three pixels constituting the one unit, a pixel that is present at one end in the direction in which the gate line is extended is a first display pixel and a pixel that is adjacent to the first display pixel and belongs to a display image that is separated into a display direction different from that of the first display pixel is a second display pixel, a source line connected to the second display pixel is adjacent to the first display pixel, and the first display pixel is a display pixel of a B (blue) color.

According to the arrangement, in a pixel other than the first display pixel, influence of crosstalk from other source line (other than a source line that supplies data to the pixel other than the first display pixel) is hard to appear because the pixel other than the first display pixel and a pixel that is connected to the other source line relate to the same image and are highly correlated to each other. On the other hand, influence of crosstalk that is caused by other source line easily appears in the first display pixel because the first display pixel and a pixel that is connected to the other source line relates to images different from each other and are not correlated.

In other words, influence of the crosstalk is concentrated in the first display pixel, by treating three pixels including R, G, and B pixels as one unit in separation of display images with the use of a parallax barrier at the time when a dual view display is performed. By arranging the first display pixel to be a B pixel that has a low correlation with luminance information, the influence of the crosstalk can be suppressed. Accordingly, influence of the crosstalk to a display screen can be reduced.

### BRIEF DESCRIPTION OF DRAWINGS

FIG. 1(a) is a plan view showing an embodiment of the present invention and a positional relationship of a picture element and R, G, and B pixels in a color liquid crystal display apparatus.

FIG. 1(b) is a diagram showing the embodiment of the present invention and illustrating an example of a structure in a case where separation is carried out by providing a barrier light-blocking layer and treating three pixels including R, G, and B pixels as one unit.

FIG. 2 is a cross sectional view schematically illustrating an arrangement of the color liquid crystal display apparatus.

FIG. 3 is a block diagram illustrating a structure of the color liquid crystal display apparatus.

FIG. 4 is a block diagram illustrating an arrangement of the color liquid crystal display apparatus according to another embodiment of the present invention.

FIG. 5 is a plan view illustrating in detail an arrangement of a display panel in the color display apparatus of FIG. 3.

FIG. 6(a) is a block diagram illustrating processing steps of a CCT correction circuit of the present invention.

FIG. 6(b) is a block diagram illustrating processing steps of a CCT correction circuit of the present invention.

FIG. 7(a) is a diagram illustrating an arrangement of a display panel in a conventional liquid crystal display apparatus.

FIG. 7(b) is a diagram illustrating a state in which a voltage is applied to a gate line.

FIG. 8 is a diagram illustrating an effect of giving a viewing angle with the use of a viewing barrier in a dual view display.

FIG. 9 is a diagram illustrating a relationship between a display screen and observers in a case where a dual view display is performed.

### BEST MODE FOR CARRYING OUT THE INVENTION

One embodiment of the present invention is explained with reference to drawings.

First, FIG. 2 schematically illustrates an arrangement of a liquid crystal display apparatus 1 of the present embodiment. The liquid crystal display apparatus 1 is a color liquid crystal display apparatus that is capable of performing a dual view display. As illustrated in FIG. 2, roughly, the liquid crystal display apparatus 1 includes a display panel 100, a parallax barrier 110, and a backlight 120.

The backlight 120 includes a light source 121 and a reflecting section 122. The reflecting section 122 reflects light that is emitted from the light source 121, so that light is irradiated on the display panel 100. Examples of the light source 121 are an LED (Light Emitting Diode), a CCFT (Cold Cathode Fluorescent Tube), and a CCFL (Cold Cathode Fluorescent Lump).

The display panel 100 is an active matrix type liquid crystal display panel in which a liquid crystal layer 103 made of a nematic liquid crystal is sandwiched between a TFT (Thin Film Transistor) substrate 101 and a CF (Color Filter) substrate 102 that are provided so as to face each other.

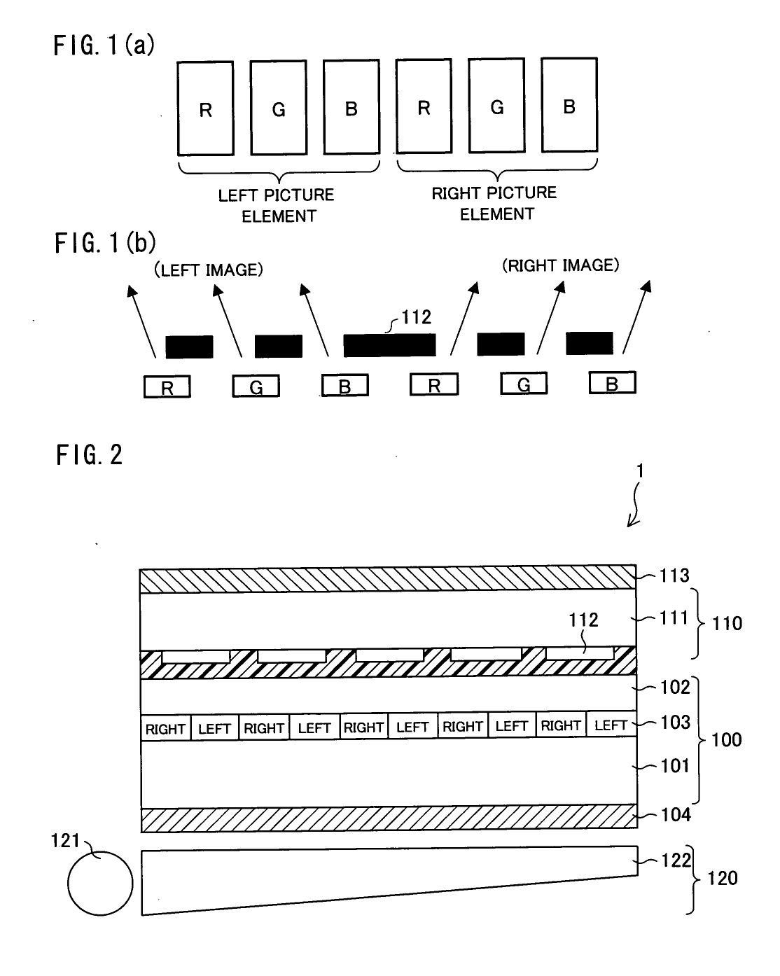

The TFT substrate 101 is provided with a plurality of source lines and a plurality of gate lines each intersecting each of the source lines. At each intersection of a source line and a gate line, a pixel is provided. As illustrated in FIG. 2, the pixels are provided along a direction in which a data signal line (not shown) is extended so that pixels of a left picture element line for an image display to a left side (an image display to a left side of the display apparatus) is provided alternatively with pixels of a right picture element line for an image display to a right side (an image display to a right side of the display apparatus). As illustrated in FIG. 1(a), each of the left picture element and the right picture element are formed so as to have R, G, and B pixels as one set.

On the CF substrate 102, a color filter layer (not shown) is provided. In the color filter layer, R, G, and B filters are provided so as to correspond to respective pixels.

On opposed surfaces of the TFT substrate 101 and the CF substrate 102 are provided with alignment films (not shown), respectively. The alignment films have been subjected to alignment treatments in directions that are substantially perpendicular to each other, respectively. A surface of the TFT substrate 101 on a side provided with the backlight 120 is provided with a polarizer 104.

The parallax barrier 110 is made of a barrier glass 111 and a barrier light-blocking layer 112. The barrier light-blocking layer 112 is formed by patterning a metal layer or a resin layer on the barrier glass 111. On a display surface side of the barrier glass 111 (an opposite side with respect to a side provided with the backlight 120), a polarizer 23 is provided.

The barrier light-blocking layer 112 is provided so as to form, for example, striped lines in a direction parallel to a direction in which the picture element lines are extended. A material of the barrier light-blocking layer 112 is not specifically limited. The barrier light-blocking layer 112 may be formed, for example, by using a photosensitive resin in which black pigments are dispersed or by patterning a metal thin film.

Further, each line of the barrier light-blocking layer 112 is provided so as to correspond to each picture element line of the display panel 100. Namely, the barrier light-blocking layer 112 separates a right image and a left image by treating three pixels including R, G, and B pixels as one unit. FIG. 1(b) illustrates an example of a structure in a case where separation is performed by providing the barrier light-blocking layer 112 and treating three pixels including R, G, and B pixels as one unit.

In this way, as illustrated in FIGS. 1(a) and 1(b), the separation of a right image and a left image with the use of the barrier light-blocking layer 112 is performed by treating the three pixels (corresponding to R, G, and B pixels) as one unit. In such a case, in a structure in which data is supplied to each pixel from a source line on the left side of the pixel, crosstalk that is caused by other source line largely influences only a pixel at the right end among the three pixels constituting one unit.

In other words, in the above-mentioned structure, a left-end pixel (R pixel in FIGS. 1(a) and 1(b)) among the three pixels constituting one unit is influenced by crosstalk from a source line that supplies data to a pixel (a center pixel among the three pixels constituting one unit: G pixel in FIGS. 1(a) and 1(b)) immediately on the right of the left-end pixel. However, the left-end pixel and the center pixel relate to an identical image. Therefore, the left-end pixel and the center pixel are highly correlated to each other. Accordingly, even when crosstalk occurs, influence of the crosstalk is hard to appear in a visible image. In the same manner, although the center pixel is influenced by crosstalk from a source line that supplies data to a right-end pixel (B pixel in FIGS. 1(a) and 1(b)) immediately on the right of the center pixel, the crosstalk is hard to appear in a visible image.

On the other hand, the right-end pixel is influenced by crosstalk from a source line that supplies data to another left-end pixel immediately on the right of the right-end pixel. Here, the right-end pixel and the another left-end pixel relates to different images, respectively.

Therefore, display data of the right-end pixel and the another left-end pixel are not correlated to each other. Therefore, the right-end pixel is influenced by crosstalk more than the left-end pixel and the center pixel.

The above explanation assumes a structure in which data is supplied to each pixel from a source line that is provided on the left of the pixel. Accordingly, the right-end pixel is largely influenced by crosstalk. However, in the present invention, it is assumed that, among three pixels constituting one unit, (i) a first display pixel is a pixel provided to one end in a direction in which the gate line is extended and (ii) a second display pixel is a pixel that is adjacent to the first display pixel and belongs to a display image separated into a display direction different from that of a display image to which the first display pixel belongs. On this assumption, the first display pixel is a pixel that is largely influenced by crosstalk. In such a case, an end pixel on a side adjacent to a source line that connects to the second display pixel is the first display pixel.

Here, the present invention has a feature such that the first display pixel is arranged to be a B pixel, as illustrated in FIGS. 1(a) and 1(b), so that influence of crosstalk to the first display pixel is reduced.

That is, the larger a change in luminance due to crosstalk that is caused by other source line is, the more easily the crosstalk is viewed. On the other hand, in regard to correlation of each of R, G, and B colors and a luminance, R and G colors have a high correlation with luminance information while B color has a low correlation with luminance information. Accordingly, by arranging the first display pixel to which the influence of crosstalk is large to be a B color pixel whose correlation with luminance information is low, a change in the luminance due to crosstalk can be suppressed and influence of the crosstalk to a display screen can be reduced.

In other words, in the liquid crystal display apparatus 1 of the present embodiment, separation of display images with the use of a parallax barrier is performed by treating the three pixels including R, G, and B pixels as one unit, when a dual view display is performed. This concentrates the influence of the crosstalk in the first display pixel. Further, by arranging the first display pixel to be a B pixel that has a low correlation with luminance information, a change in the luminance can be suppressed, thereby reducing the influence to the display screen.

Moreover, in the liquid crystal display apparatus 1, it becomes possible to perform a display in which crosstalk is further suppressed if crosstalk correction is carried out in the first display pixel in which influence of the crosstalk is large. In this case, compared with a case where crosstalk correction is carried out with respect to all of the R, G, and B pixels, processing that concerns the crosstalk correction can be reduced. Accordingly, an arrangement of a correction circuit can be simplified.

The following explains an arrangement in which color crosstalk correction mentioned above is carried out.

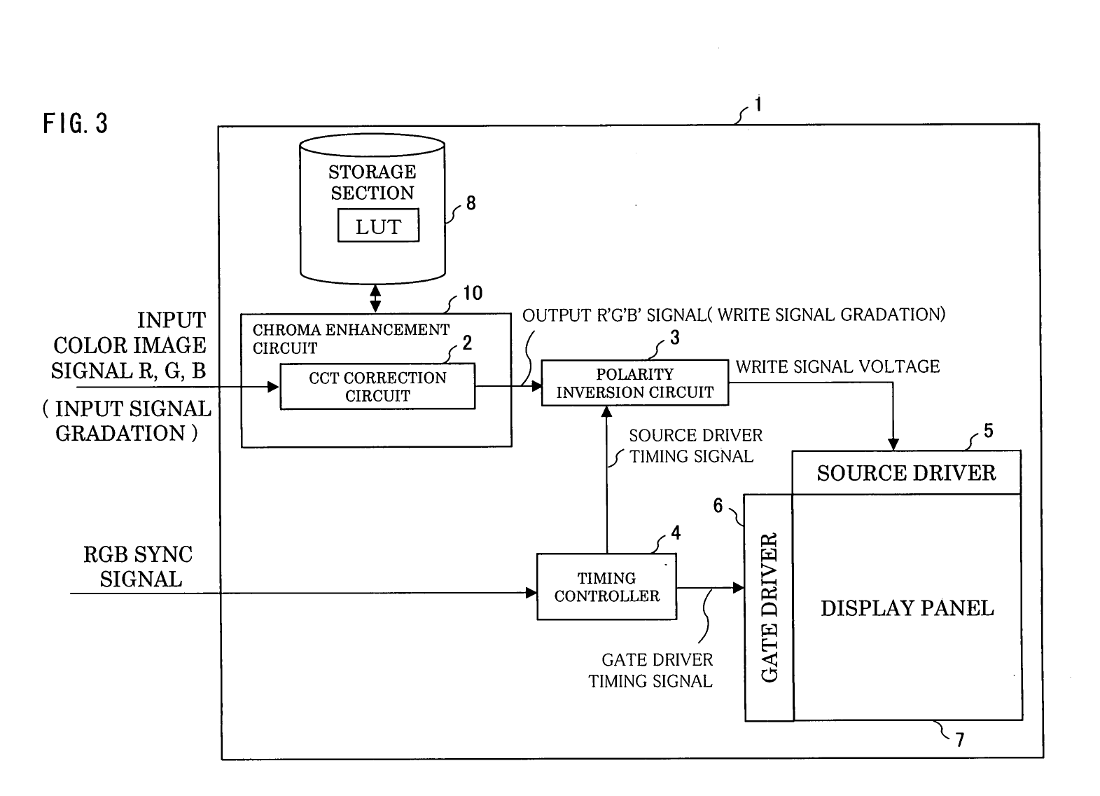

FIG. 3 is one embodiment of the liquid crystal display apparatus 1 of the present invention. As illustrated in FIG. 3, the liquid crystal display apparatus 1 includes a CCT (Color Crosstalk) correction circuit 2 (correction circuit), a polarity inversion circuit 3, a timing controller 4, a source driver 5, a gate driver 6, a display panel 7, and a storage section 8. Note that arrangements that do not relate to the present invention are drastically omitted in FIG. 3.

The CCT correction circuit 2 corrects an input signal gradation (input color signal) that is made of a blue signal B indicating a gradation level of a B color that is inputted from outside, and outputs a write signal gradation (output color image signal) B′ for the display panel 7. A correction level of this correction is determined by B and an adjacent Rx that is provided next to B via other source bus line. Specifically, in the case of 1-dot 1H inversion driving method, the following corrections are made: B′←B−α(α>0) at B<Rx; and B′←B+α(α>0) at B>Rx. Note that B, Rx, and α may be processed as gradation signals or processed as voltages after converted into the voltages. In a case where R, Rx, and α are processed as voltages, versatility of the present arrangement increases. However, a circuit for real number processing, polarity processing, or the like becomes complicated. Further, a correction table also becomes complicated. On the other hand, in a case where R, Rx, and α are processed as gradation numbers, the circuit becomes simple. However, the correction needs to be made for each gradation setting of a device. Further, because a polarity cannot be considered, an accidental error is contained. According to actual measurements of the inventor, a sufficient correction effect could be obtained by either method. Therefore, R, Rx, and α are subjected to digital processing simply as gradation numbers. Further, an LUT for every 16 gradations is produced for a correction amount and an intermediate gradation is interpolated.

Note that the CCT correction circuit 2 may be included in a chroma enhancement circuit 10. Moreover, the CCT correction processing is not performed with respect to a red signal R that indicates a gradation level of an R color and a green signal G that indicates a gradation level of a G color. The red signal R and the green signal G are directly outputted as write signal gradations (output color image signals) R′ and G′ for the display panel 7.

The polarity inversion circuit 3 determines write voltage signals (analog data) for respective display pixels in the display panel 7, according to the write signal gradations R′, G′, and B′ (digital data) that are outputted from the CCT correction circuit 2.

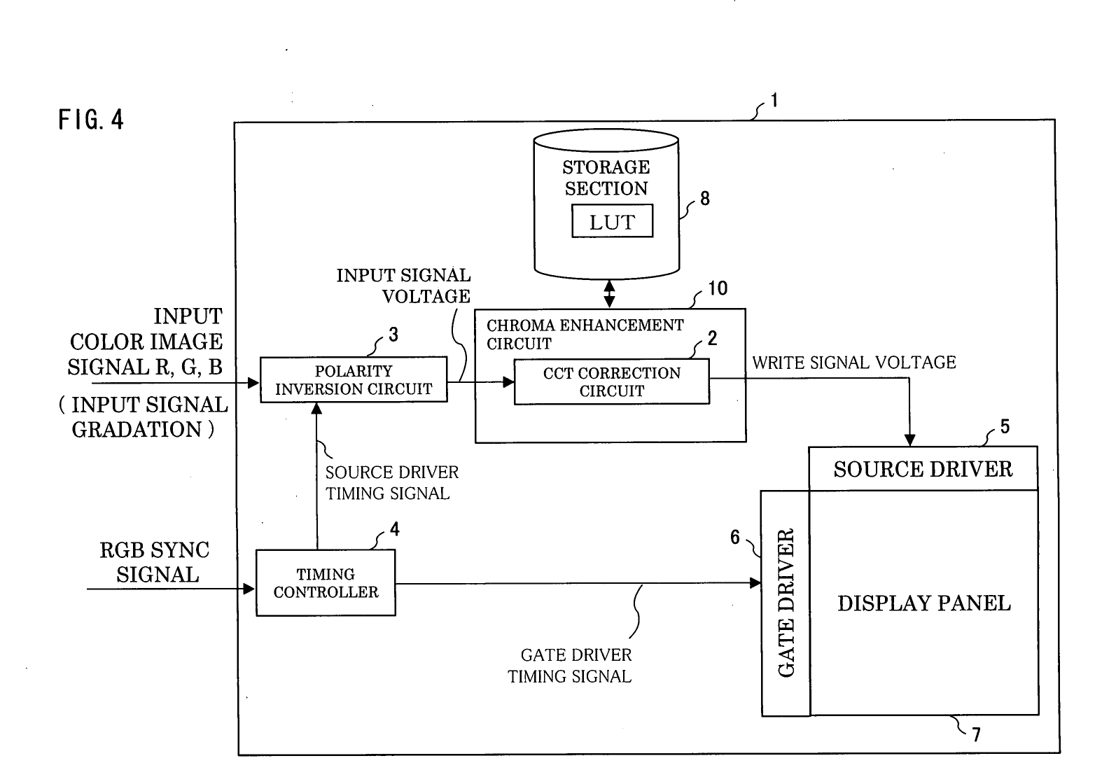

As illustrated in FIG. 4, it is possible to provide the CCT correction circuit in a subsequent stage of the polarity inversion circuit 3 in the present liquid crystal display apparatus 1 (display device). That is, the CCT correction circuit 2 as illustrated in FIG. 4 corrects the input signal voltages (analog data) from the polarity inversion circuits 3 and outputs write voltage signals (analog data).

The timing controller 4 generates a source driver timing signal for driving the source driver 5 and a gate driver timing signal for driving the gate driver 6, according to an inputted RGB sync signal. Note that the source driver timing signal is inputted into the source driver 5 via the polarity inversion circuit 3.

The source driver 5 drives each source line that is connected via a TFT to each display pixel provided in the display panel 7, so that the write voltage that is determined in the polarity inversion circuit 3 is applied to the each display pixel. Note that the source driver 5 may be integrally formed with the polarity inversion circuit 3. Moreover, the gate driver 6 drives each gate line that is connected via a TFT to each display pixel provided in the display panel 7.

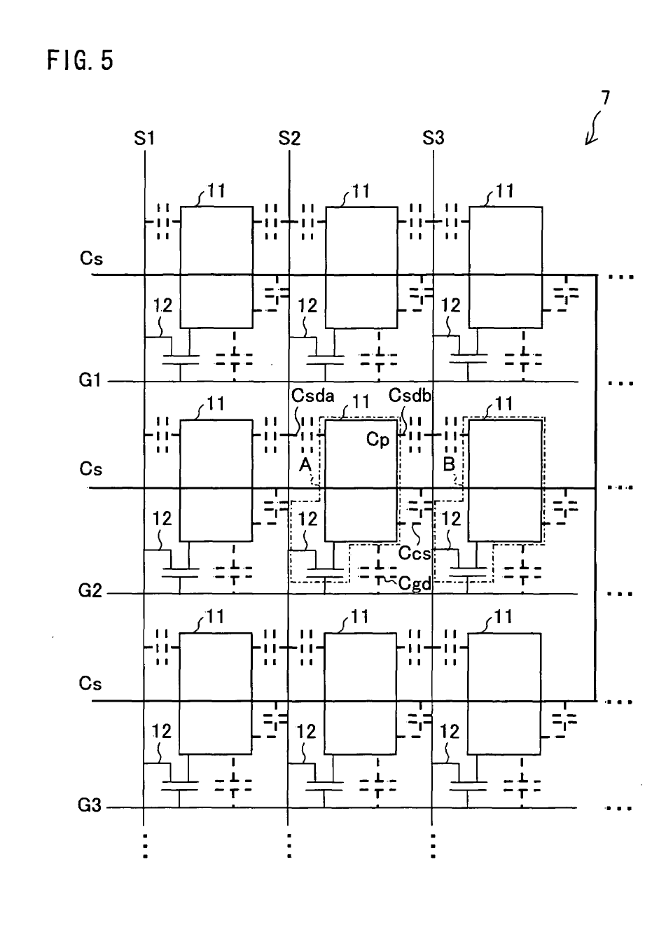

The display panel 7 performs an image display, by driving a plurality of display pixels that are provided in a matrix with the use of a plurality of source lines and a plurality of gate lines. Specifically, as illustrated in FIG. 5, source lines Si (i is an integer) and gate lines Gj (j is an integer) are provided to be orthogonal. At each intersection of source lines and gate lines, each display pixel that includes a pixel electrode 11 and a switching element 12 is provided.

Here, in case that, in regard to two display pixels that are driven by the same gate line G2, as illustrated in FIG. 5, among the display pixels, a source line S3 that is adjacent to a source line S2 connecting to a first display pixel (A) and forms parasitic capacitances with a pixel electrode of the first display pixel (A) is connected to a second display pixel (B), that is, the second display pixel is connected to a source line that is not connected to the first display pixel and one of two source lines that overlap (be adjacent to) the pixel electrode of the first display pixel, parasitic capacitances Csda, Csdb, Cgd, and Ccs are formed on the periphery of the display pixel (A) as follows:

the parasitic capacitance Csda: a parasitic capacitance that is formed between a source line for driving the display pixel (A) and the display pixel (A);

the parasitic capacitance Csdb: a parasitic capacitance that is formed between a source line for driving the display pixel (B) and the display pixel (A);

the parasitic capacitance Cgd: a parasitic capacitance that is formed between a gate line for driving the display pixel (A) and the display pixel (A); and

the parasitic capacitance Ccs: a parasitic capacitance that is formed between a storage capacitor electrode (line) and the display pixel (A).

Accordingly, if each display pixel is driven as conventional not via the CCT correction circuit 2, a problem of crosstalk occurs. The problem of the crosstalk is such that a display gradation of a target display pixel is influenced by a voltage that is applied to a source line driving other display pixel and becomes a gradation that is different from a desired gradation. For example, in an arrangement of FIG. 5, regarding the display pixel (A) as the first display pixel, a display gradation of the display pixel (A) is influenced by a voltage applied to the source line S3 that drives the display pixel (B) as the second display pixel.

In the liquid crystal display apparatus 1 of the present embodiment, the CCT correction circuit 2 (See FIGS. 2 and 1) is provided for the purpose of improving the problem of the crosstalk that occurs as mentioned above. However, the above problem of crosstalk noticeably occurs particularly only in a B color pixel as mentioned above. The following explanation assumes that the display pixel (A) is a B color pixel and the display pixel (B) is an R color pixel.

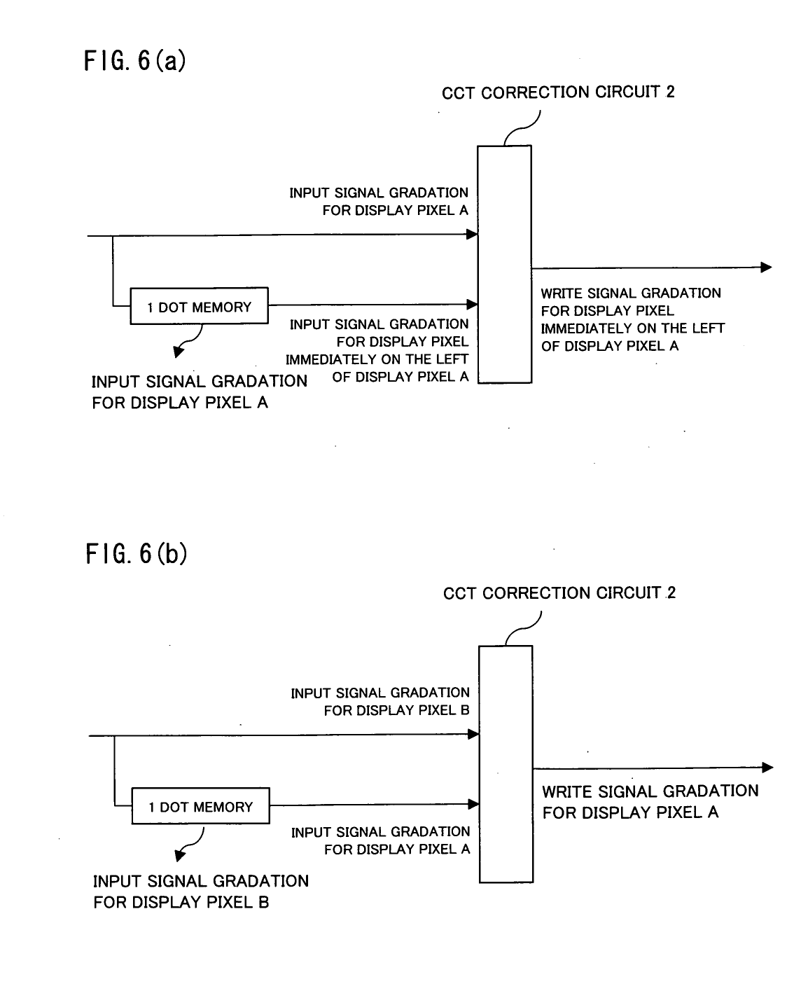

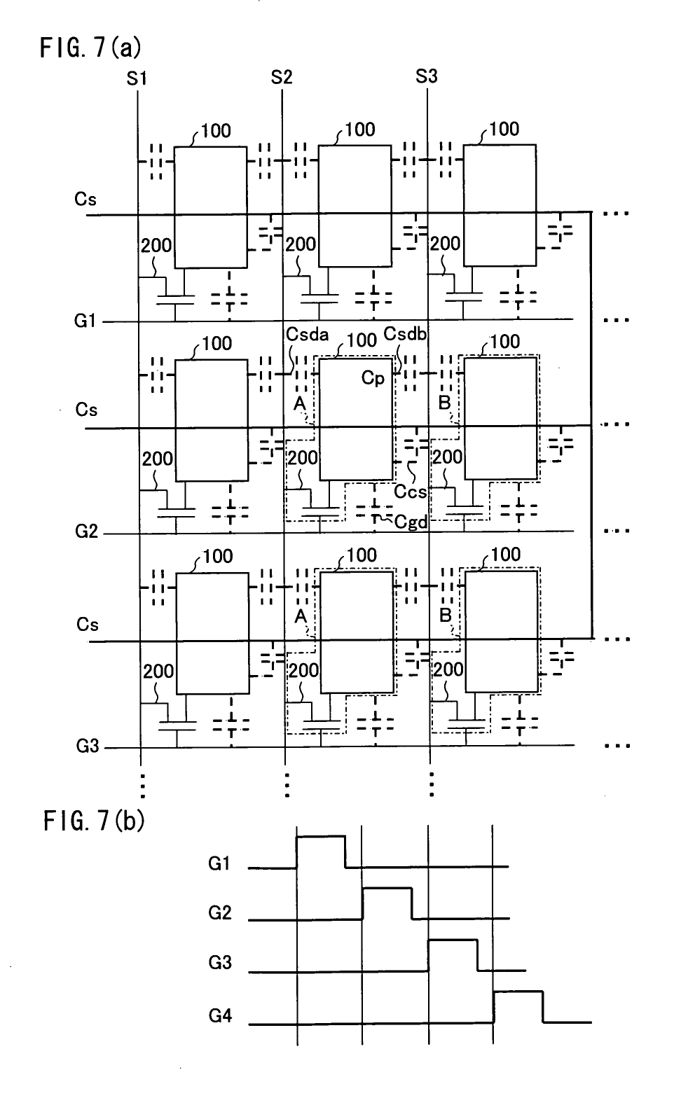

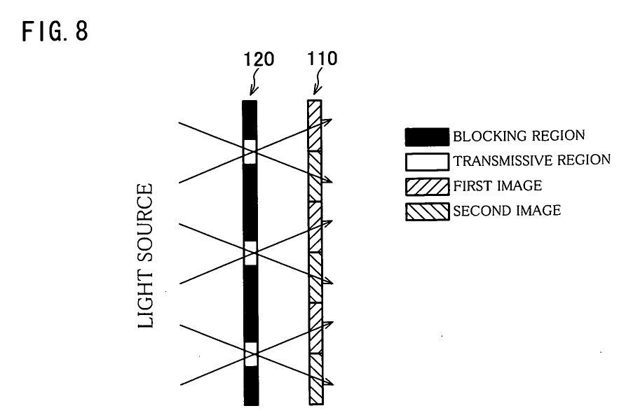

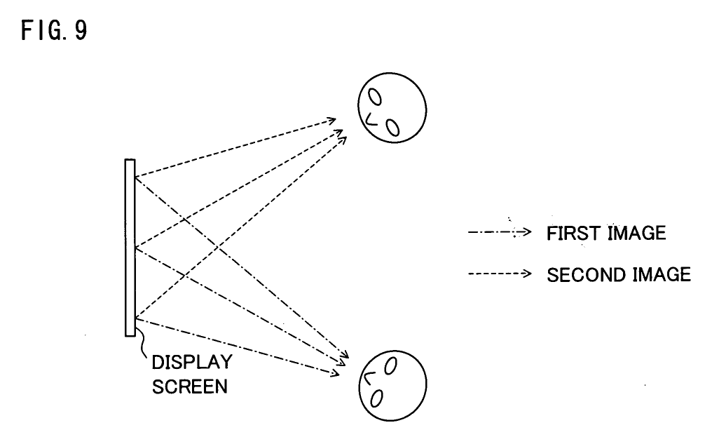

With reference to FIG. 6, the following explains the step of outputting a write signal by the CCT correction circuit 2.

FIG. 6 is a block diagram that explains a case where, with the use of the CCT correction circuit 2, an input signal gradation of the display pixel (A) is corrected according to an input signal gradation of the display pixel (B) and the corrected input signal gradation of the display pixel (A) is outputted as a write signal gradation of the display pixel (A) to the polarity inversion circuit 3.

First, an input signal gradation of the display pixel (A) is inputted into the CCT correction circuit 2 as well as stored in a 1 dot memory (FIG. 6(a)). Then, as illustrated in FIG. 6(b), an input signal gradation of the display pixel (B) is inputted into the CCT correction circuit 2 as well as stored in the 1 dot memory. At this time, the input signal gradation of the display pixel (A) that is stored in the 1 dot memory in advance is outputted from the 1 dot memory, and the input signal gradation of the display pixel (A) is inputted into the CCT correction circuit 2 along with the input signal gradation of the display pixel (B). The CCT correction circuit 2 corrects the input signal gradation of the display pixel (A) from this 1 dot memory according to the input signal gradation of the display pixel (B). Then, the CCT correction circuit 2 outputs the corrected input signal gradation of the display pixel (A) to the polarity inversion circuit 3 as a write signal gradation of the display pixel (A).

As explained above, the write signal gradation for a B color display pixel that is a display pixel (A) is corrected by the CCT correction circuit 2 to a corrected gradation of the input signal gradation for the display pixel (A), according to an input signal gradation or a write signal gradation of an R color display pixel that is a display pixel (B). This makes it possible to reduce an amount of crosstalk. In other words, this can reduce an amount of crosstalk in the B color display pixel which crosstalk occurs between the parasitic capacitance Csd and the display pixel, and makes it possible to obtain an appropriate color balance of a display that is performed by the display apparatus.

Specifically, the correction is performed so that the input gradation level for the display pixel (A) becomes a gradation level Lₒᵤₜ that is calculated by Lₒᵤₜ=LA +F (LA, LB),

where: LA is a gradation level of the display pixel (A) that is indicated by digital data; LB is a gradation level of the display pixel (B) that is indicated by the digital data; and F (LA, LB) is a function that has LA and LB as input values.

The correction of the gradation level LA as mentioned above corrects the input signal gradation for the display pixel (A) by using a gradation level that is digital data. Accordingly, it becomes possible to reduce crosstalk by a simple processing. That is, in case where a voltage to be applied to the display pixel (A) is corrected by using analog data that indicates the voltage to be applied, processing may become complicated. This is because the processing may require the number of bits larger than that of a case where digital data is handled. In a correction processing that uses digital data, such complication of processing can be avoided.

Further, it is preferable to define F (LA, LB)=k(LA−LB) (note k>0) in a case where LA is smaller than a predetermined threshold value or F (LA, LB) as a function that outputs a constant value in a case where the LA is larger than a predetermined threshold value.

This is because a value of a corrected value F (LA, LB) to be provided to LA so that crosstalk is reduced increases monotonously in accordance with a value of LA, until LA reaches a predetermined threshold value (128th gradation). Moreover, in the case of LA that is greater than the threshold value (128th gradation), a clear correlation between LA and F (LA, LB) becomes absent. Further, because an error ratio of a stimulus value becomes low, the crosstalk is reduced by a relatively rough correction in which, for example, Lₒᵤₜ is outputted as a result of adding a constant value to LA.

Accordingly, by defining F (LA, LB) as explained above, Lₒᵤₜ can be obtained in a simple processing.

Further, a plurality of integers are extracted from integers that are included in 0 to maximum gradation levels and values of F (LA, 0) (where the plurality of integers are used as LA, respectively) are stored in a lookup table in advance so as to correspond to corresponding values of LA. On the other hand, a value of F (LA, LB) in which LA that is not stored in the lookup table is inputted is interpolated based on (i) a value of LA that is stored in the lookup table, (ii) a value of F (LA, 0) that corresponds to the value of LA, and (iii) values of LA and LB that satisfy F (LA, LB)=0. This arrangement is more preferable.

According to the arrangement, the value of F (LA, LB) can be obtained by using the lookup table. Therefore, by preparing the lookup table for each of display device types in advance and storing thus obtained lookup table in a storage section 8 (See FIG. 3), an appropriate value of F (LA, LB) can be obtained according to the display device types.

Further, when LA>LB, it is preferable that the above interpolation is carried out by linear interpolation. This is because interpolation by a straight line is the simplest method among interpolation methods.

When LA<LB, the term is disregarded and a correction value is often set to 0 in color crosstalk correction in a normal display. This is because the case of LA<LB has a luminance variation amount that is smaller than that in a case of LA>LB and, generally, the variation amount is submerged in luminance variation of a further adjacent pixel (G with respect to B). However, in the present invention, correction should be made in the case of LA<LB, because there is no correlation between LA and LB in terms of images.

The explanation above describes a method in which a write signal gradation for the display pixel (A) is determined by using an input signal gradation level LA of the display pixel (A) and a gradation (input signal gradation/write signal gradation) level LB of the display pixel (B). However, it is not necessary to use this processing. That is, a write signal voltage for the display pixel (A) may be determined according to analog data that indicates a write signal voltage for the display pixel (A) and analog data that indicates a voltage (input signal voltage/write signal voltage) to be applied to the display pixel (B). The following explains a procedure of this correction. Note that the correction using the analog data that indicates a voltage to be applied is executed by the CCT correction circuit in the same manner as the correction using digital data that indicates a gradation level. However, it is necessary to provide, as illustrated in FIG. 4, the polarity inversion circuit 3 in a preceding stage of the CCT correction circuit, because analog data that indicates a voltage to be applied to each pixel needs to be inputted into the CCT correction circuit.

In the procedure of correction according to analog data that indicates a voltage to be applied, the following F(g) is assumed as a correction value:

F(g)=Csd·(Ugad−Ubad)/Cp·(U(g+1)−U(g)),

where: Cp is a capacitance of the display pixel (A); Csd is a capacitance value of a parasitic capacitance that is formed between a source line S3 to which the display pixel (B) is connected and a pixel electrode of the display pixel (A); U(g) is an input signal voltage for the display pixel (A) in a case where a level of the input signal gradation is g; Ugad is an input signal voltage or a write signal voltage for the display pixel (B); and Ubad is an applied voltage that is applied to a common electrode that is opposed to the pixel electrodes of the display pixels (A) and (B) (an input signal voltage for the display pixel (A) at the time when the display pixel (A) performs a black display). A write signal gradation for the display pixel (A) is calculated by adding an input signal gradation for the display pixel (A) to this correction value F(g). Then, a voltage corresponding to thus obtained write signal gradation is assumed as a write signal voltage for the display pixel (A). Particularly, by setting Csd/Cp to a small value of approximately 0.020, a low correction value F(g) can be obtained.

Note that a reference potential of each voltage may be a ground potential. Moreover, the Cp above is obtained by adding Ccs, Csda, Csdb, and Cgd to a liquid crystal capacitance of the display pixel (A). It is clear that Cp may be a liquid crystal capacitance because the liquid crystal capacitance (capacitance value) is dominant, or Cp may be a liquid crystal capacitance to which at least one of the Ccs, Csda, Csdb, Cgd, and a capacitance that is formed in the display pixel (A) is added.

Alternatively, in case where a voltage of an effective value Va needs to be applied to the display pixel (A) so that a desired gradation is displayed, a write signal voltage for the display pixel (A) is assumed to be a voltage V(A) that is expressed in V(A)=(Cp*Va−Cgd*Vg−Csdb*V(B)+Ccs*Vc)/(Cp+Csda), where: V(B) is an input signal voltage or write signal voltage for the display pixel (B); Csda is a capacitance value of a parasitic capacitance that is formed between the source line S2 to which the display pixel (A) is connected and a pixel electrode of the display pixel (A); Csdb is a capacitance value of a parasitic capacitance that is formed between the source line G3 to which the display pixel (B) is connected and the pixel electrode of the display pixel (A); Cgd is a capacitance value of a parasitic capacitance that is formed between the gate line G2 that is connected to the display pixel (A) and the pixel electrode of the display pixel (A); Ccs is a capacitance value of a parasitic capacitance that is formed between a storage-capacitor electrode Cs, which is provided so as to correspond to the display pixel (A), and a drain electrode of a switching element of the display pixel (A); Vg is an applied voltage that is applied to the gate line G2; Vc is an applied voltage that is applied to the storage-capacitor electrode Cs; and Cp is a capacitance value of the display pixel (A).

The above explanation explains, as an example, a case where the CCT correction circuit 2 (chroma enhancement circuit 10) is realized by only hardware. However, the CCT correction circuit 2 is not limited to this. All or a part of the member may be realized by a combination of a program that realizes a function explained above and hardware (computer) that executes the program. For an example, the CCT correction circuit 2 or chroma enhancement circuit 10 may be realized as a device driver that is used at the time of driving the display panel 7, with the use of a computer that is connected to the liquid crystal display apparatus 1. Moreover, in case where the CCT correction circuit 2 or chroma enhancement circuit 10 is realized by a conversion substrate that is externally provided to the liquid crystal display apparatus 1 and operation of the circuit that realizes the CCT correction circuit 2 or the chroma enhancement circuit 10 can be changed by rewiring a program such as software, the circuit may be operated as the CCT correction circuit 2 (chroma enhancement circuit 10) of the embodiment by providing the software and changing the operation of the circuit.

In these cases, when hardware capable of executing the function above is prepared, the CCT correction circuit 2 (chroma enhancement circuit 10) of the embodiment can be realized by causing the hardware to execute the program.

The CCT correction processing explained above is a correction method that is disclosed in Patent Document 1 and only an example. The CCT correction processing applicable to the present invention is not limited to this. In other words, in the present invention, by concentrating influence of crosstalk in a B pixel that has a low correlation with luminance information, an effect of suppressing crosstalk can be obtained. Therefore, even when the CCT correction processing above is performed, it is easy to put more importance on simplicity of processing than preciseness of correction in the processing.

For example, simple correction processing with respect to data of a B color becomes possible by breaking down luminance information in display data to R and G information (something simple) according to visibility and outputting, as a correction coefficient with respect to B, intensity of thus obtained R information to which intensity a coefficient is added. Here, it is preferable that the coefficient that is added to the intensity of R information is provided in the form of a lookup table.

The following explains a modified example capable of simplifying the CCT correction circuit 2.

Because correction specialized in processing of B and Rx becomes possible, crosstalk correction can be further simplified. As explained above, the information of R as well as G has a very high correlation with luminance information Y. In a device of the present invention, generally, inputs of two systems (a luminance signal Y and color difference signals such as Pb and Pr) are simultaneously carried out for intended use of the device. In general, each of these input signals is supplied to the device after independently converted into digital R, G, and B and integrated. However, in the device, crosstalk correction is determined only between B and Rx. Moreover, in the device, Rx and Y are highly correlated with each other, and only B varies. Accordingly, correction of a color difference signal Pb of blue according to a Y value of a reference side can provide the substantially same effect. Although the color difference signal Pb may be corrected by using digital YUV, the correction can be realized by an analog circuit that adds a value Y as a reference value to Pb in a case where a relatively rough correction is acceptable for the intended use of the device. Accordingly, a correction circuit can be realized by a very simple circuit configuration.

As mentioned above, in a liquid crystal display of the present invention allowing a display mode (a dual view display) in which a different image can be displayed with respect to each of a plurality of display directions to be realized by bonding a liquid crystal panel and a parallax barrier, the liquid crystal panel being provided with a display pixel including a switching element and a pixel electrode which display pixel corresponds to each intersection of a plurality of gate lines and a plurality of source lines: the parallax barrier separates display images viewed in different directions, respectively, by treating, as one unit, three pixels including R, G, and B pixels provided in a direction in which a gate line is extended; and in a case where, among the three pixels constituting the one unit, a pixel that is present at one end in the direction in which the gate line is extended is a first display pixel and a pixel that is adjacent to the first display pixel and belongs to a display image that is separated into a display direction different from that of the first display pixel is a second display pixel, a source line connected to the second display pixel is adjacent to the first display pixel, and the first display pixel is a display pixel of a B (blue) color.

According to the arrangement, in a pixel other than the first display pixel, influence of crosstalk from other source line (other than a source line that supplies data to the pixel other than the first display pixel) is hard to appear because the pixel other than the first display pixel and a pixel that is connected to the other source line relate to the same image and are highly correlated to each other. On the other hand, influence of crosstalk that is caused by other source line (other than a source line that supplies data to the first display pixel) easily appears in the first display pixel because the first display pixel and a pixel that is connected to the other source line relates to images different from each other and are not correlated.

In other words, influence of the crosstalk is concentrated in the first display pixel, by treating three pixels including R, G, and B pixels as one unit in separation of display images with the use of a parallax barrier at the time when a dual view display is performed. By arranging the first display pixel to be a B pixel that has a low correlation with luminance information, the influence of the crosstalk can be suppressed. Accordingly, influence of the crosstalk to a display screen can be reduced.

Further, the above liquid crystal display apparatus may include a correcting section correcting, according to an input signal for the first display pixel and an input signal for the second display pixel, the input signal for the first display pixel and outputting, as a write signal for the first display signal, the input signal that has been corrected.

According to the arrangement, crosstalk correction can be carried out in the first display pixel in which the influence of the crosstalk is concentrated. Compared with a case in which correction is carried out for all of the R, G, and B pixels, processing related to the crosstalk correction can be reduced. Moreover, an arrangement of a correction circuit can be simplified. Further, a display in which crosstalk is suppressed becomes possible.

Moreover, in the liquid crystal display apparatus, it is preferable that the correcting section reads out the write signal for the first display pixel from a lookup table, according to the input signal for the first display pixel and the input signal for the second display pixel.

According to the arrangement, the crosstalk correction with respect to data of the first display pixel becomes possible by using simple processing such as reading out data from a lookup table.

1. A liquid crystal display apparatus allowing a display mode in which a different image can be displayed with respect to each of a plurality of display directions to be realized by bonding a liquid crystal panel and a parallax barrier,
the liquid crystal panel being provided with a display pixel including a switching element and a pixel electrode which display pixel corresponds to each intersection of a plurality of gate lines and a plurality of source lines, wherein:
the parallax barrier separates display images viewed in different directions, respectively, by treating, as one unit, three pixels including R, G, and B pixels provided in a direction in which a gate line is extended; and
in a case where, among the three pixels constituting the one unit, a pixel that is present at one end in the direction in which the gate line is extended is a first display pixel and a pixel that is adjacent to the first display pixel and belongs to a display image that is separated into a display direction different from that of the first display pixel is a second display pixel,
a source line connected to the second display pixel is adjacent to the first display pixel, and
the first display pixel is a display pixel of a B (blue) color.

2. The liquid crystal display apparatus as set forth in claim 1, comprising:
a correcting section correcting, according to an input signal for the first display pixel and an input signal for the second display pixel, the input signal for the first display pixel and outputting, as a write signal for the first display signal, the input signal that has been corrected.

3. The liquid crystal display apparatus as set forth in claim 2, wherein:
the correcting section reads out the write signal for the first display pixel from a lookup table, according to the input signal for the first display pixel and the input signal for the second display pixel.
